(19) United States
(12) Patent Application Publication
(10) Pub. No.: US 2012/0215702 A1
(43) Pub. Date: Aug. 23, 2012

(54) System and Related Methods of Managing Real Estate Open Houses

(76) Inventor: Scott Thibeault, Calgary (CA)

(21) Appl. No.: 13/031,840

(22) Filed: Feb. 22, 2011

(51) Int. Cl. G06Q 50/00

(52) U.S. Cl. 705/313

(57) ABSTRACT

A method and system are presented for scheduling open house viewings and matching available open house hosts for these viewings via an internet web site. Methods include a seller access at an internet website server to book an open house host for an open house. The seller, at the internet website, submits open house booking information pertaining to an open house. The open house booking information includes property location, open house date and open house start time and open house end time. An open house host is matched to the booked open house based upon the open house booking information. Upon conclusion of the open house, the open house host accesses the internet website server and submits an open house report via the website server. The open house report is communicated to the seller.

### FIELD OF THE INVENTION

This invention pertains, generally, to the field of real estate sales and, particularly, to a system and related methods of managing real estate open houses including matching a qualified open house host with a scheduled open house.

### BACKGROUND OF THE INVENTION

In the field of real estate, holding open houses is a common method used to attract potential buyers to view properties for sale. At an open house, it is necessary to have some person host the open house to, among other functions, greet and sign in viewers of the property, oversee the open house, determine if a guest is interested in buying the property, check that the house is clean and open for viewing, see that workers and pets will not hinder the viewing, ensure that nothing in the house is damaged or stolen, and perform other responsibilities according to the situation.

It is common in real estate for real estate agents, realtors, and other professionals to attend and oversee open houses, but with the supply of available properties far exceeding the supply of interested buyers, real estate agents, realtors, and other professionals may have far more properties to promote. They may be busy with other aspects of their business. A real estate professional may have many open houses or viewings on the same day. Accordingly, there exists a need for a system and method of matching qualified open house hosts with open houses.

### SUMMARY OF THE INVENTION

Embodiments of the present invention address this need by providing a system and method of matching available qualified hosts to scheduled open houses by scheduling these hosts to be present at times, dates, and locations of those open houses which need qualified hosts.

An object of the present invention is to provide a host open house service that is accessed by computing devices running an internet web browser.

Another object of the present invention is to provide a hosted open house service that manages open house hosts and ensures qualifications of the open house hosts.

Another object of the present invention is to provide a hosted open house service that includes a website interface for facilitating the primary aspects of the booking of an open house, the matching of an open house host with a booked open house, and the reporting of open house activity.

To achieve these and other advantages, in general, and in one aspect, a method for booking an open house host via an internet web site is provided. The method includes the steps of:
a) receiving access at an internet website server by a seller desiring to book an open house host for an open house;
b) receiving open house booking information at the internet website by the seller, the booking information pertaining to an open house and including property location, open house date and open house start time and open house end time;
c) matching an open house host to the open house based upon received open house booking information;
e) receiving access at the internet website server by the open house host; receiving open house report information at the internet website server by the registered open house host; and
f) communicating the open house report information to the seller.

In general, and in another aspect, a method for booking an open house host and reporting open house information via an internet web site is provided. The method includes the steps of:
a) receiving access at website of a hosted open house service provider by a seller that is registered with the hosted open house service provider and that desires to book an open house host for an open house;
b) receiving open house booking information at the website by the seller, the booking information pertaining to an open house and including property location, open house date and open house start time and open house end time;
c) matching an open house host from a group of open house hosts registered with the hosted open house service provider based upon received booking information by automated generation and transmitting of an electronic communication by a computing system of the hosted open house service provider to one or more of the group of open house hosts and receiving a reply to the electronic communication by the one or more open house hosts of the group of open house hosts by the computing system;
d) receiving access at the internet website by the matched open house host;
e) receiving open house report information at the internet website by the matched open house host; and
f) communicating the open house report information to the seller.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 is a system diagram of a hosted open house service in accordance with the principals of the present invention;

FIG. 2 is a flow diagram illustrating a method of an embodiment of the present invention; and

FIG. 3 is a high level process diagram depicting user interaction with the website and method thereof in an embodiment of the present invention.

### DETAILED DESCRIPTION OF THE INVENTION

In this description, references to “one embodiment” or “an embodiment” mean that the feature being referred to is included in at least one embodiment of the invention. Moreover, separated references to “one embodiment” in this description do not necessarily refer to the same embodiment. Illustrated embodiments are not mutually exclusive unless so stated and except as will be readily apparent to those of ordinary skill in the art. Thus, the invention may include any variety of combinations and/or integrations of the embodiments described herein.

Various embodiments of the present invention may be implemented through systems and methods described in more detail below. According to one embodiment, novel aspects of the present invention include the ability for users to request the services of an open house host over the internet using a web browser, the matching of an available open house host with an open house requiring a host, and the ability to monitor, screen and track open house metrics and host performance.

For the description herein, a seller is a person or organization wanting to sell or lease specified real property to others. The seller may be owners of homes wanting to sell without agents (“for-sale-by-owner”), owners of homes listed with agents, new home builders or condo developers with show suites, real estate agents, realtors, attorneys, employees of banks or mortgage companies, and the general public. A host, also called “qualified host”, may be licensed real estate agents, realtors, or other persons qualified in the hosting of an open house.

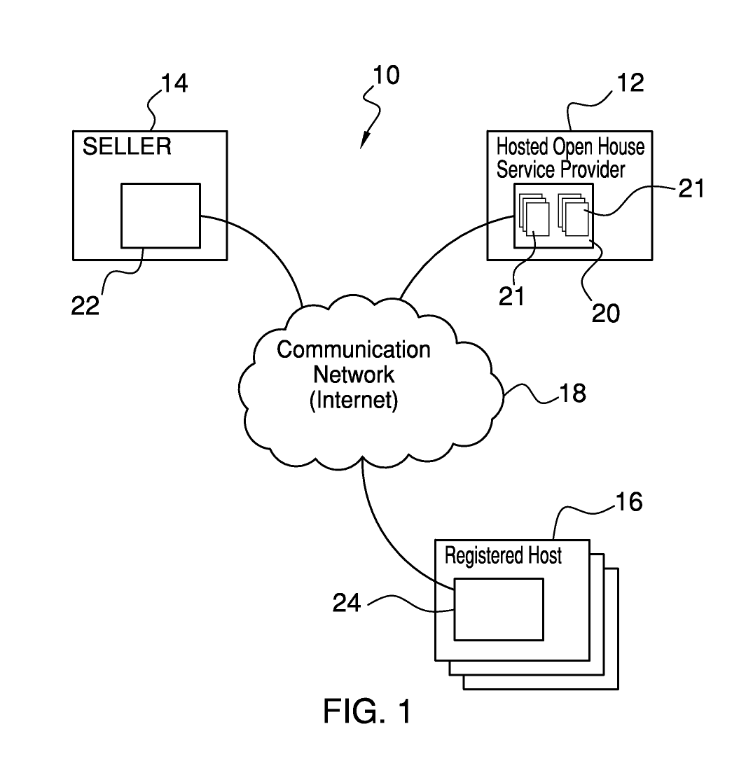

With reference to FIG. 1, there is illustrated a diagram of a hosted open house system 10 in accordance with the present invention. In an embodiment, the system 10 includes a hosted open house service provider 12, a seller 14 and one or more registered open house hosts 16. The open house service provider 12, the seller 14 and the one or more hosts 16 are each connected to a communication network 18, such as the internet, cellular network, or any other data communication network, to facilitate the communication between the service provider, the seller and the one or more hosts in carrying out the system and methods herein.

The open house service provider 12 includes a computer system 20 including one or more networked computers running one or more software applications configured to manage visitor access, the registration of a new seller, the registration of a new host, manage registered seller and registered host account profiles, manage open house scheduling, manage seller access and interaction with the service provider, manage registered host access and interaction with the service provider and to manage databases 21 relating to the above information and/or containing open house information, seller information and registered host information. Open house information may include scheduled open houses, details relating to a property for which an open house is scheduled, open house historical data, related seller, related host, etc. Seller information may include, name, contact information, client identification, billing information, open house historical data, seller preferences, etc. Registered host information may include name, contact information, host identification, qualifications, special abilities, such as bi-lingual, etc., training information, payment information, historical data, etc.

In an embodiment, the computer system 20 of the open house service provider 12 includes a web server operating to manage/host a website, for example www.hostedopenhouse.com, that provides a user interface that is accessible from a web browser operating on a user's computing device that is connected to a communication network 18. For example, a seller 14 desiring to book a host 16 for an open house would access the website through a web browser operating on a computing device 22 that is connected to the network 18. Computing device 22 may by a personal computer, a mobile phone, a portable digital assistant, a portable computing device or any other device that is capable of running a web browser and capable of being connected to the internet or other data communication network that is currently known or may become available in the future. Likewise, a seller 14 using a computing device 22 may access the website to manage the seller's user profile that is registered with the open house service provider 12.

Further, each registered open house host 16 is required to have a computing device 24 that is connected or connectable to the communication network 18 to access the website and for communication between the host and open house service provider 12. Similarly, computing device 12 may be a personal computer, a mobile phone, a portable digital assistant, a portable computing device or any other device that is capable of running a web browser and capable of being connected to the internet or other data communication network that is currently known or may become available in the future. In an embodiment, each registered open house host 16 is required to carry a cellular telephone while sitting an open house that is capable of receiving and sending SMS communications from the open house service provider 12, as will be further explained below. Likewise, a registered host 16 using a computing device 24 may access the website to manage the host's user profile that is registered with the open house service provider 12.

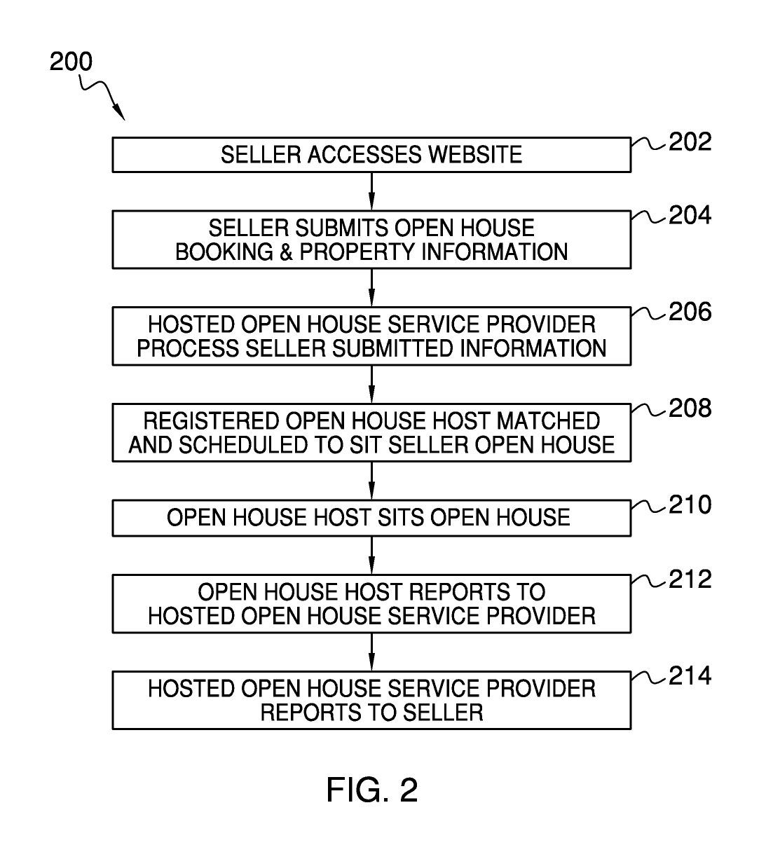

With reference to FIG. 2, there is illustrated flowchart broadly depicting a method 200 accordingly to an embodiment of the present invention. Initially, at step 202, seller 14 desiring to book an open house host 16 for an open house accesses the website of the open house service provider 12 using a web browser operating on a computing device 22 that is connected to the communication network 18. Once the seller 14 is authenticated by the open host service provider's computing system 20, at step 204, the seller through interaction with the website submits a request to book a host to sit for an open house. The request includes information pertaining to the property having the open house, such as property location, open house date, open house start and finish time and special considerations such as key lock box location and code, pets that are on the property, specific open host qualifications or skills or any other information required or deemed appropriate by the open house service provider. In an embodiment, the seller 14 may be required to pay for the booking of the open house host during booking and/or before the processing of the booking request. Payment may be made using a payment gateway on the website or using a prestablished payment account. At step 206, the open host service provider's computing system 20 processes the booking request and related information submitted by the seller 14 in the previous step.

At step 208, the open house service provider 12 coordinates with registered hosts 16 to match a host with the open house requirements for the purpose of sitting the open house. This process is performed automatically through electronic communication between the computing system 20 and registered host computing device 24. For example, in an embodiment, the communication may be an automatically generated Email communication that is sent to a registered host for reply by the host to accept the available open house sitting. The automatically generated Email communication may include an embedded response form or program that may be operated at least in part on the host computing device 24 to facilitate either the acceptance or rejection of the open house sitting. In other embodiments, an automated communication between the open house service provider 12 and one or more registered hosts 16 may include an interactive voice response or SMS messaging.

At step 210, a scheduled open house host 16 sits the booked open house. At step, 212 upon conclusion of the open house, the open house host 16, using a computing device 24 accesses the website of the open house service provider and through interaction with the website submits an open house report detailing the activities of the open house. Activities that are reported may include the names of visitors/viewers of the open house, any disturbances, noticed theft or vandalism and/or information pertaining to interest in the purchase or sale of the property.

Once the open house report is submitted, payment to the host 16 for the service of sitting the open house is processed.

At step 214, the open house service provider 12 processes the details of the open house report that was submitted by the open house host 16 in the prior step, and then automatically generates and sends an electronic communication to the seller 14, which includes the details of the open house report. The electronic communication may be an Email communication that is automatically generated by computing system 20. The open house report is also available to the seller 14 by accessing the seller's profile on the open house service provider's website.

In an embodiment, at or during step 208 the computing system 20 operates to match a registered open house host with the booked open house. A registered host 16 is selected by communicating through automated electronic communication, such as, for example email, sms text, automated voice calling, etc. In an embodiment, a serial method may be used to match a host 16 with a booked open house, for example a program operating on the computing system 20 may operate to serially compare registered open house host data against the booked open house data to determine if a host is available and qualified to host the open house. If that host is not available, the program will select the next host on the list. Once the program finds a match with a host who will be available, it communicates with the selected host to find out if that selected host will agree to host the open house. If the selected host will host the open house, the program follows the steps of communicating the relevant information to the selected host. If the selected host declines to host the open house at that time and date, the program goes back to the list and searches for a match with the next available host on the list. Each time a match is made, the program contacts the selected host until a selected host accepts. If the list is exhausted before a host is found who will accept, the program notifies a facilitator of the hosted open house service provider 12 to find an available host, for example by reviewing the received responses from contacted open house hosts to determine if an accepted response was erroneously processed by the computer system 20.

Alternatively, or in combination with the above described serial method, at step 208 hosts can sign onto the website then direct the program to display all or some of the open houses within the time and date range specified by this host. This is the “parallel method”. The host can, if host wishes, select an open house to host from this list. It is contemplated other methods of matching open house hosts with booked open houses, and automatically and electronically communicating with registered open house hosts may be implemented and still remain within the scope of this invention.

In an embodiment, at or during step 210 the host 16 travels to the location for the open house a short time prior to the open house and places signs indicating there will be an open house. The host 16 also places directional signs so guests can more easily find the location for the open house. The 16 host should arrive at the open house site with sufficient time before the start of the open house to perform minor tasks including unlocking doors, opening windows, turning on lights, and generally seeing to it that the property is in good condition for showing. In most cases it will take less than half an hour to perform these tasks but different open houses may require different times. Host 16 will then using computing device 24 will either send an electronic message, such as an SMS message to the open house service provider 12 which will be received by the computing system 20 or through accessing the website submit a notification, that host has arrived and begun the open house process.

In an embodiment, at or during step 210 the computing system 20 will periodically and automatically generate and send an electronic communication to the host 16. The host 16 will have a prescribe period of time to respond to this electronic communication with the computing device 24 as an indication all is going smoothly. If no response is received within the prescribed time period, the host open house service provider 12 may deem it necessary to notify local police to come by the open house and check.

Further, it is contemplated the open house host will arrive at the property to conduct the open house as per the list of policy and procedures prescribed by the host open house service provider and for the time period requires as per the open house booking When guests arrive, host has the guests sign in to a register and checks identification. This guest list can be used later for contacting those guests who showed interest in the property. The count of guests is sent to the computer at a later time so the success of the open house can be measured and steps taken in the future to improve turnout. In the extreme case, if there was theft or damage, the guest list can be turned over the local authorities for investigation.

Additionally, after the open house, the host will close down the property as per the hosted open house policy and procedures and instructions provided by the property owner and/or seller.

At the time set for ending the open house, host will see that all guests have left the premises. Then host will shut all windows, generally make the premises neat, turn off lights, lock all doors, and perform such other tasks as are specified by sellers. Additionally, the host using a computing device will send an electronic communication to the open house service provider advising the host is leaving the property.

Host will then provide a report on the open house. This report will contain the number of guests plus any problems noted in case there is to be another open house at a later date. Problems might include need for snow removal, need for cleaning, need for grass mowing, and the like. Once these reports are received by facilitator, payment of a portion of the fee paid by seller of this property will be sent to host.

If there is an interested party who has more questions or wishes to attempt to purchase the property, the host is instructed to contact the seller of the property as soon as possible. If the particular host is a licensed agent/realtor then this host may have the opportunity to handle the sale with the buyer and earn a sale commission.

In further embodiments, all registered open house hosts will be required to go through training prescribed by the host open house service provider. Additionally, registered hosts will be required to have a valid driver's license and motor vehicle, smart mobile phone with email and web browsing capabilities, and may be required to possess their own open house signs.

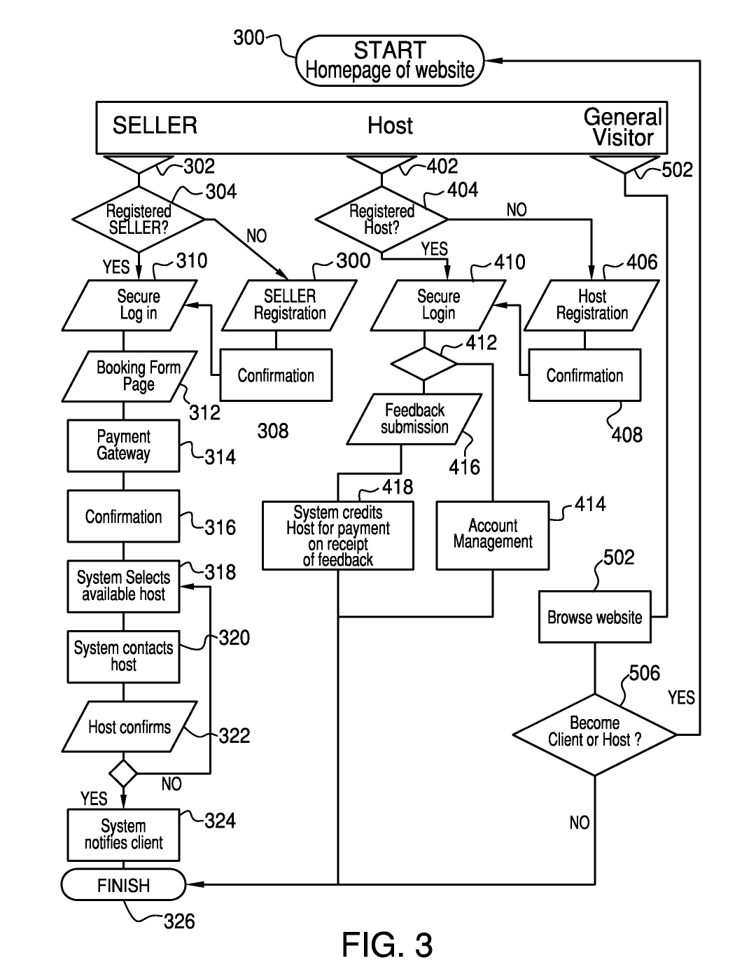

With reference to FIG. 3, there is illustrated a high level process diagram depicting user interaction with the website and method thereof in an embodiment of the present invention. The process begins at 300 Start, and there are three basic types of users accessing the website, which include sellers, hosts, and general visitors. At time of first access of the system, users will inform the system whether they are sellers, hosts, or general visitors. The system will take sellers down the path beginning at 302, hosts down the path beginning at 402, and visitors down the path beginning at 502.

If the user is a seller, at step 304, the system operates to determine if the seller has previously registered with the system. If the seller has not so registered, at 306 the seller registers and this registration is confirmed at 308. If the seller is already registered, at 310 the system goes through the process of checking that the seller is already registered during the secure log in process. The system at 310 passes control to the scheduling form page at 312. Here the seller supplies information regarding the open house to be held and for which the seller requires a host as described above. Once the seller has provided this information, the computer will display to the seller a form which will vary with the type of seller requesting the open house. Once the scheduling form page or pages are completed, control passes to the payment gateway at 314. Here, payment information is gathered and processed through whatever means will serve the purpose. In one embodiment, the payment information is processed through a merchant service. In another embodiment, the payment information is processed through seller's credit card. Control then flows to another confirmation step at 316. Here, the merchant service, credit card service, or other means respond to queries by the system that the seller has the necessary funds or credit.

At 318, the system goes through the host portion of the system's database to select a host who will be available and who can be at the specified location at the time and date of the open house. At 320, the system contacts the selected host to notify said host with the details of the scheduled open house and will request a reply with confirmation from said selected host that host will be available and willing to host the open house. At 322, selected host does or does not confirm. If selected host does not confirm, control goes back to 318 where the system selects a different host and repeats the steps beginning at 318. Once a selected host confirms, at 324 the system notifies the seller that a host has confirmed. Next, at 326 the system completes its termination processes. Said termination processes may vary depending on the type of user and the user's needs.

If the user is a host, at step 404, the system determines if the host is a registered host. If host is not registered, the system, at step 406, goes through the host registration process and then goes through a confirmation process at 408 and then to step 410. At step 410, the system goes through the secure log in process for registered hosts. Following secure log in, at step 412, the system determines if the host is submitting the open house report or wishes to manage his/her account. If it is determined the host desires to manage his/her account the process proceeds to step 414. If it is determined the host is accessing the website for report submission the process proceeds to step 416. Once feedback submission is confirmed, control is passed to step 418 where payment to the host is processed their service.

If user is a General Visitor, at step 504, visitor browses the website. Visitor indicates a preference at 506 for becoming a Seller or a Host. If Visitor wishes to become either, control takes Visitor to the appropriate path for 302 Seller or 402 Host. If Visitor does not wish to become either, control goes to 326 Finish, as above.

A number of embodiments of the present invention have been described. Nevertheless, it will be understood that various modifications may be made without departing from the spirit and scope of the invention. Accordingly, other embodiments are within the scope of the following claims.

What is claimed is:

1. A method for booking an open house host via an internet web site, the method comprising the steps of:
receiving access at an internet website server by a seller desiring to book an open house host for an open house;
receiving open house booking information at said internet website by said seller, said booking information pertaining to an open house and including property location, open house date and open house start time and open house end time;
matching an open house host to said open house based upon received open house booking information;
receiving access at said internet website server by said open house host;
receiving open house report information at said internet website server by said registered open house host; and
communicating said open house report information to said seller.

2. The method of claim 1, wherein during the matching step:
an open house host is matched from a group of registered open house hosts.

3. The method of claim 1, wherein said open house report information includes the names of each person who visited the open house.

4. The method of claim 1, further comprising the step of:
sending an electronic communication to the matched open house host at periodic intervals during said open house to confirm the progress of said open host via reply electronic communication by the matched open house.

5. A method for booking an open house host and reporting open house information via an internet web site, the method comprising the steps of:
receiving access at website of a hosted open house service provider by a seller that is registered with said hosted open house service provider and that desires to book an open house host for an open house;
receiving open house booking information at said website by said seller, said booking information pertaining to an open house and including property location, open house date and open house start time and open house end time;
matching an open house host from a group of open house hosts registered with said hosted open house service provider based upon received booking information by automated generation and transmitting of an electronic communication by a computing system of the hosted open house service provider to one or more of said group of open house hosts and receiving a reply to said electronic communication by said one or more open house hosts of said group of open house hosts by said computing system;
receiving access at said internet website by the matched open house host;
receiving open house report information at said internet website by said matched open house host; and
communicating said open house report information to said seller.

6. The method of claim 5, wherein said open house report information includes the names of each person who visited the open house.

7. The method of claim 5, further comprising the steps of:
sending an electronic communication to the matched open house host at periodic intervals during said open house to confirm the progress of said open host via reply electronic communication by the matched open house.
